(19) United States
(12) Patent Application Publication
(10) Pub. No.: US 2025/0320358 A1
(43) Pub. Date: Oct. 16, 2025

(54) ANTI-DRIP POLYCARBONATE COMPOSITIONS

(71) Applicant: SHPP GLOBAL TECHNOLOGIES B.V., Bergen op Zoom (NL)

(72) Inventors: Peter Hendrikus Theodorus VOLLENBERG, Evansville, IN (US); Tom L. EVANS, Mt Vernon, IN (US)

(21) Appl. No.: 18/868,549

(22) PCT Filed: May 25, 2023
(86) PCT No.: PCT/IB2023/055376

§ 371 Date: Nov. 22, 2024

(30) Foreign Application Priority Data
May 25, 2022 (EP) 22175415.3

(51) Int. Cl. C08L 69/00; C08J 3/20

(52) U.S. Cl. CPC C08L 69/00; C08J 3/201; C08J 2369/00; C08J 2469/00; C08J 2483/04; C08J 2483/10; C08L 2201/02; C08L 2205/025; C08L 2205/035

(57) ABSTRACT

A polycarbonate composition comprises a linear homopolycarbonate and optionally, a styrene-containing copolymer; a poly(carbonate-siloxane) comprising about 10 wt % to less than about 30 wt % siloxane, present in amount effective to provide about 1 to about 6 wt % siloxane, based on the total weight of the composition; an ultra-high molecular weight poly dimethylsiloxane, present in an amount effective to provide greater than about 0.3 to less than about 0.9 wt % siloxane, based on the total weight of the composition; a flame retardant; and optionally, an additive composition. Molded samples of the polycarbonate compositions have a UL94 flame test rating or V-0 at a 1.5 mm thickness, exhibit anti-drip properties, and can be essentially halogen-free, i.e., the polycarbonate compositions include about 900 parts per million (ppm) or less of each of chlorine, bromine, and optionally fluorine and also include about 1500 ppm or less of total chlorine, bromine, and fluorine content.

### BACKGROUND

This disclosure relates to polycarbonate compositions, and in particular to anti-drip polycarbonate compositions, methods of manufacture, and uses thereof.

Polycarbonates are useful in the manufacture of articles and components for a wide range of applications, from automotive parts to electronic appliances. Because of their broad use, it is desirable to provide polycarbonates that when molded into articles are flame retardant.

There accordingly remains a need in the art for polycarbonate compositions that are flame retardant. It would be a further advantage if the compositions were essentially halogen-free.

### SUMMARY

The above-described and other deficiencies of the art are met by a polycarbonate composition including: a polycarbonate composition including: a linear homopolycarbonate and optionally, a styrene-containing copolymer; a poly(carbonate-siloxane) including about 10 to less than about 30 wt % siloxane, present in amount effective to provide about 1 to about 6 wt % siloxane content, based on the total weight of the polycarbonate composition; an ultra-high molecular weight polydimethylsiloxane, present in an amount effective to provide greater than about 0.3 wt % to less than about 0.9 wt % siloxane content, based on the total weight of the composition, wherein the weight average molecular weight of the polydimethylsiloxane is at least 100,000 grams per mole as determined by gel permeation chromatography according to polystyrene standards; a flame retardant; and optionally, an additive composition, wherein the linear homopolycarbonate, the optional styrene-containing copolymer, the poly(carbonate-siloxane), the ultra-high molecular weight polydimethylsiloxane, the flame retardant, and the optional additive composition total 100 wt %.

In another aspect, a method of manufacture comprises combining the above-described components to form a polycarbonate composition.

In yet another aspect, an article comprises the above-described polycarbonate composition.

In still another aspect, a method of manufacture of an article comprises molding, extruding, or shaping the above-described polycarbonate composition into an article.

The above described and other features are exemplified by the following detailed description, examples, and claims.

### DETAILED DESCRIPTION

Due to the miniaturization of electronic parts and market trends, there is a need for flame retardant articles that are essentially halogen-free. As used herein, the phrase “essentially halogen-free” is as defined by IEC 61249-2-21 or UL 746H. According to International Electrochemical Commission, Restriction Use of Halogen (IEC 61249-2-21), a composition should include 900 parts per million (ppm) or less of each of chlorine and bromine and also include 1500 ppm or less of total bromine, chlorine, and fluorine content. According to UL 746H, a composition should include 900 ppm or less of each of chlorine, bromine, and fluorine and 1500 ppm or less of the total chlorine, bromine, and fluorine content. The bromine, chlorine, and fluorine content in ppm may be calculated from the composition or measured by elemental analysis techniques. Conventional flame retardants can include or exclude halogens, but commonly employed anti-drip agents include PTFE-encapsulated styrene-acrylonitrile copolymers (e.g., TSAN) and thus include fluorine. Flame retardants that are not brominated, chlorinated, or fluorinated have been used in conventional polycarbonate compositions, but an anti-drip agent is usually present in combination with the flame retardant, causing the halogen content of the composition to exceed the 1500 ppm total halogen limit per IEC 61249-2-21 and UL 746H. Similarly, when flame retardants that are not brominated or chlorinated, but are fluorinated are used in combination with a fluorinated anti-drip agent, then the halogen content of the composition due to the presence of fluorine exceeds the 1500 ppm total halogen limit per IEC 61249-2-21 or UL 746H. Therefore, it would be a particular advantage if the anti-drip agent was non-fluorinated, so that the anti-drip agent does not contribute halogen content to the total halogen content of the compositions. When a non-fluorinated anti-drip agent is used, a variety of flame retardants that include or exclude halogens can be used in combination with the non-fluorinated anti-drip agent so that the compositions can be considered “essentially halogen-free” per IEC 61249-2-21 or UL 746H.

The inventors hereof have discovered that polycarbonate compositions including a linear homopolycarbonate and optionally, a styrene-containing copolymer, a flame retardant, a poly(carbonate-siloxane) and an ultra-high molecular weight polydimethylsiloxane, can provide anti-drip properties without compromising the flame retardance, for example, the UL-94 flame test rating. Advantageously, the polycarbonate compositions can have a UL-94 flame test rating of V-0 at a thickness of 1.5 mm or 2.9 mm, an absence of drips, and be considered “essentially halogen-free” per IEC 61249-2-21 or UL 746H. A further advantage is that the V-0 flame test rating and the anti-drip properties were not achieved at the expense of the aesthetic qualities of the molded samples of the polycarbonate compositions. Indeed, the polycarbonate compositions can include colorants to provide colored articles, such as, for example, white or black articles.

“Polycarbonate” as used herein means a polymer having repeating structural carbonate units of formula (1)

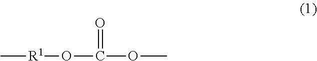

in which at least 60 percent of the total number of R¹ groups contain aromatic moieties and the balance thereof are aliphatic, alicyclic, or aromatic. In an aspect, each R¹ is a C₆₋₃₀ aromatic group, that is, contains at least one aromatic moiety. R¹ can be derived from an aromatic dihydroxy compound of the formula HO—R¹—OH, in particular of formula (2)

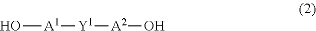

wherein each of A¹ and A² is a monocyclic divalent aromatic group and Y¹ is a single bond or a bridging group having one or more atoms that separate A¹ from A². In an aspect, one atom separates A¹ from A². Preferably, each R¹ can be derived from a bisphenol of formula (3)

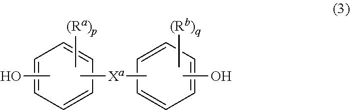

wherein R^{a} and R^{b} are each independently a halogen, C₁₋₁₂ alkoxy, or C₁₋₁₂ alkyl, and p and q are each independently integers of 0 to 4. It will be understood that when p or q is less than 4, the valence of each carbon of the ring is filled by hydrogen. Also in formula (3), X^{a} is a bridging group connecting the two hydroxy-substituted aromatic groups, where the bridging group and the hydroxy substituent of each C₆ arylene group are disposed ortho, meta, or para (preferably para) to each other on the C₆ arylene group. In an aspect, the bridging group X^{a} is single bond, —O—, —S—, —S(O)—, —S(O)₂—, —C(O)—, or a C₁₋₆₀ organic group. The organic bridging group can be cyclic or acyclic, aromatic or non-aromatic, and can further comprise heteroatoms such as halogens, oxygen, nitrogen, sulfur, silicon, or phosphorous. The C₁₋₆₀ organic group can be disposed such that the C₆ arylene groups connected thereto are each connected to a common alkylidene carbon or to different carbons of the C₁₋₆₀ organic bridging group. In an aspect, p and q is each 1, and R^{a} and R^{b} are each a C₁₋₃ alkyl group, preferably methyl, disposed meta to the hydroxy group on each arylene group.

In an aspect, X^{a} is a C₃₋₁₈ cycloalkylidene, a C₁₋₂₅ alkylidene of formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e})— wherein R^{e} is a divalent C₁₋₁₂ hydrocarbon group. Groups of these types include methylene, cyclohexylmethylidene, ethylidene, neopentylidene, and isopropylidene, as well as 2-[2.2.1]-bicycloheptylidene, cyclohexylidene, 3,3-dimethyl-5-methylcyclohexylidene, cyclopentylidene, cyclododecylidene, and adamantylidene.

In another aspect, X^{a} is a C₁₋₁₈ alkylene, a C₃₋₁₈ cycloalkylene, a fused C₆₋₁₈ cycloalkylene, or a group of the formula -J¹-G-J²- wherein J¹ and J² are the same or different C₁₋₆ alkylene and G is a C₃₋₁₂ cycloalkylidene or a C₆₋₁₆ arylene.

For example, X^{a} can be a substituted C₃₋₁₈ cycloalkylidene of formula (4)

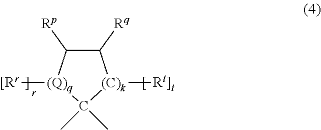

wherein R^{r}, R^{p}, R^{q}, and R^{t} are each independently hydrogen, halogen, oxygen, or C₁₋₁₂ hydrocarbon groups: Q is a direct bond, a carbon, or a divalent oxygen, sulfur, or —N(Z)— where Z is hydrogen, halogen, hydroxy, C₁₋₁₂ alkyl, C₁₋₁₂ alkoxy, C₆₋₁₂ aryl, or C₁₋₁₂ acyl; r is 0 to 2, t is 1 or 2, q is 0 or 1, and k is 0 to 3, with the proviso that at least two of R^{r}, R^{p}, R^{q}, and R^{t} taken together are a fused cycloaliphatic, aromatic, or heteroaromatic ring. It will be understood that where the fused ring is aromatic, the ring as shown in formula (4) will have an unsaturated carbon-carbon linkage where the ring is fused. When k is one and q is 0, the ring as shown in formula (4) contains 4 carbon atoms, when k is 2, the ring as shown in formula (4) contains 5 carbon atoms, and when k is 3, the ring contains 6 carbon atoms. In an aspect, two adjacent groups (e.g., R^{q} and R^{t} taken together) form an aromatic group, and in another aspect, R^{q} and R^{t} taken together form one aromatic group and R^{r} and R^{p} taken together form a second aromatic group. When R^{q} and R^{t} taken together form an aromatic group, R^{p} can be a double-bonded oxygen atom, i.e., a ketone, or Q can be —N(Z)— wherein Z is phenyl.

Bisphenols wherein X^{a} is a cycloalkylidene of formula (4) can be used in the manufacture of polycarbonates containing phthalimidine carbonate units of formula (1a)

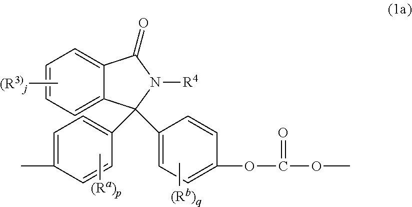

wherein R^{a}, R^{b}, p, and q are as in formula (3), R³ is each independently a C₁₋₆ alkyl, j is 0 to 4, and R₄ is hydrogen, C₁₋₆ alkyl, or a substituted or unsubstituted phenyl, for example a phenyl substituted with up to five C₁₋₆ alkyls. For example, the phthalimidine carbonate units are of formula (1b)

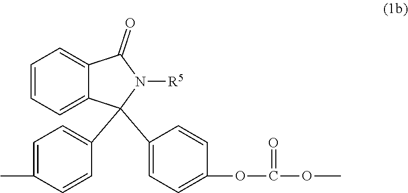

wherein R⁵ is hydrogen, phenyl optionally substituted with up to five 5 C₁₋₆ alkyls, or C₁₋₄ alkyl. In an aspect in formula (1b), R⁵ is hydrogen, methyl, or phenyl, preferably phenyl. Carbonate units (1b) wherein R⁵ is phenyl can be derived from 2-phenyl-3,3′-bis(4-hydroxy phenyl)phthalimidine (also known as 3,3-bis(4-hydroxyphenyl)-2-phenylisoindolin-1-one, or N-phenyl phenolphthalein bisphenol.

Other bisphenol carbonate repeating units of this type are the isatin carbonate units of formula (1c) and (1d)

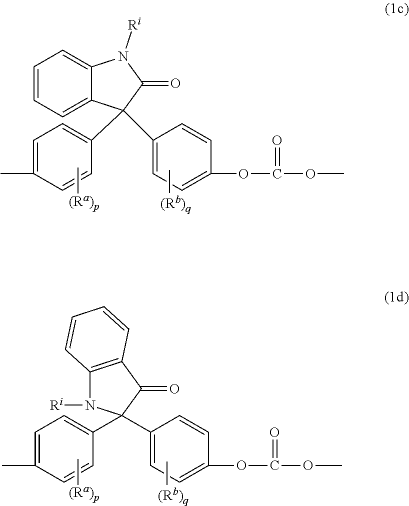

wherein R^{a} and R^{b} are each independently a halogen, C₁₋₁₂ alkoxy, or C₁₋₁₂ alkyl, p and q are each independently 0 to 4, and Rⁱ is C₁₋₁₂ alkyl, phenyl optionally substituted with 1 to 5 C₁₋₁₀ alkyl, or benzyl optionally substituted with 1 to 5 C₁₋₁₀ alkyl. In an aspect, R^{a} and R^{b} are each methyl, p and q are each independently 0 or 1, and Rⁱ is C₁₋₄ alkyl or phenyl.

Other examples of bisphenol carbonate units derived from of bisphenols (3) wherein X^{a} is a substituted or unsubstituted C₃₋₁₈ cycloalkylidene include the cyclohexylidene-bridged bisphenol of formula (1e)

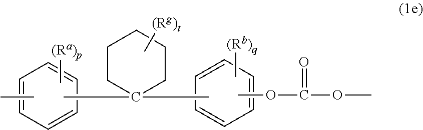

wherein R^{a} and R^{b} are each independently C₁₋₁₂ alkyl, R^{g} is C₁₋₁₂ alkyl, p and q are each independently 0 to 4, and t is 0 to 10. In a specific aspect, at least one of each of R^{a} and R^{b} are disposed meta to the cyclohexylidene bridging group. In an aspect, R^{a} and R^{b} are each independently C₁₋₄ alkyl, R^{g} is C₁₋₄ alkyl, p and q are each 0 or 1, and t is 0 to 5. In another specific aspect, R^{a}, R^{b}, and R^{g} are each methyl, p and q are each 0 or 1, and t is 0 or 3, preferably 0. In still another aspect, p and q are each 0, each R^{g} is methyl, and t is 3, such that X^{a} is 3,3-dimethyl-5-methyl cyclohexylidene.

Examples of other bisphenol carbonate units derived from bisphenol (3) wherein X^{a} is a substituted or unsubstituted C₃₋₁₈ cycloalkylidene include adamantyl units of formula (1f) and fluorenyl units of formula (1g)

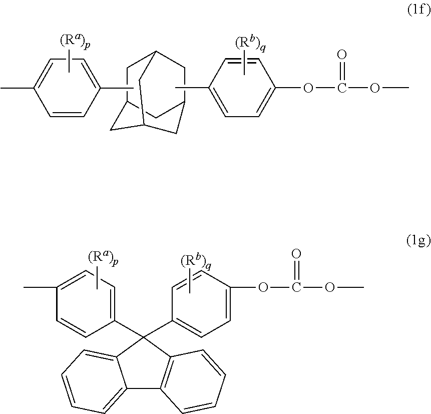

wherein R^{a} and R^{b} are each independently C₁₋₁₂ alkyl, and p and q are each independently 1 to 4. In a specific aspect, at least one of each of R^{a} and R^{b} are disposed meta to the cycloalkylidene bridging group. In an aspect, R^{a} and R^{b} are each independently C₁₋₃ alkyl, and p and q are each 0 or 1; preferably, R^{a}, R^{b} are each methyl, p and q are each 0 or 1, and when p and q are 1, the methyl group is disposed meta to the cycloalkylidene bridging group. Carbonates containing units (1a) to (1g) are useful for making polycarbonates with high glass transition temperatures (Tg) and high heat distortion temperatures.

Other useful dihydroxy compounds of the formula HO—R¹—OH include aromatic dihydroxy compounds of formula (6)

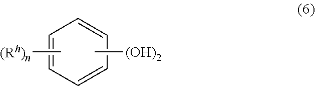

wherein each R^{h} is independently a halogen atom, C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4. The halogen is usually bromine.

Some illustrative examples of specific dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxy thianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or a combination thereof.

Specific examples of bisphenol compounds of formula (3) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-2-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). A combination can also be used. In a specific aspect, the polycarbonate is a linear homopolymer derived from bisphenol A, in which each of A¹ and A² is p-phenylene and Y¹ is isopropylidene in formula (3).

The polycarbonate composition can include a bisphenol A polycarbonate homopolymer, also referred to as a bisphenol A homopolycarbonate. The bisphenol A polycarbonate homopolymer has repeating structural carbonate units of the formula (1).

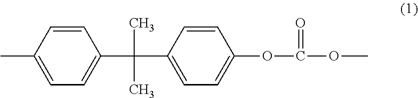

Polycarbonates can be manufactured by processes such as interfacial polymerization and melt polymerization, which are known, and are described, for example, in WO 2013/175448 A1 and WO 2014/072923 A1. An end-capping agent (also referred to as a chain stopper agent or chain terminating agent) can be included during polymerization to provide end groups, for example monocyclic phenols such as phenol, p-cyanophenol, and C₁₋₂₂ alkyl-substituted phenols such as p-cumyl-phenol, resorcinol monobenzoate, and p- and tertiary-butyl phenol, monoethers of diphenols, such as p-methoxyphenol, monoesters of diphenols such as resorcinol monobenzoate, functionalized chlorides of aliphatic monocarboxylic acids such as acryloyl chloride and methacryoyl chloride, and mono-chloroformates such as phenyl chloroformate, alkyl-substituted phenyl chloroformates, p-cumyl phenyl chloroformate, and toluene chloroformate. Combinations of different end groups can be used. Branched polycarbonate blocks can be prepared by adding a branching agent during polymerization, for example trimellitic acid, trimellitic anhydride, trimellitic trichloride, tris-p-hydroxyphenylethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents can be added at a level of 0.05 to 4.0 wt % (wt %), for example, 0.05 to 2.0 wt %. Combinations including linear polycarbonates and branched polycarbonates can be used.

The polycarbonates can have an intrinsic viscosity, as determined in chloroform at 25° C., of 0.3 to 1.5 deciliters per gram (dl/gm), preferably 0.45 to 1.0 dl/gm. The polycarbonates can have a weight average molecular weight (Mw) of 10,000 to 200,000 grams per mole (g/mol), preferably 20,000 to 100,000 g/mol, as measured by gel permeation chromatography (GPC), using a crosslinked styrene-divinylbenzene column according to polystyrene standards and calculated for polycarbonate. GPC samples are prepared at a concentration of 1 mg per ml, and are eluted at a flow rate of 1.5 ml per minute. The linear homopolycarbonate can include a bisphenol A polycarbonate homopolymer. The linear bisphenol A polycarbonate homopolymer can have a weight average molecular weight of 15,000 to 25,000 g/mol, preferably 17,000 to 25,000 g/mol, as determined by GPC according to polystyrene standards and calculated for polycarbonate. The linear bisphenol A polycarbonate homopolymer can have a weight average molecular weight of 26,000 to 40,000 g/mol, preferably 27,000 to 35,000 g/mol, as determined by GPC according to polystyrene standards and calculated for polycarbonate.

In an aspect, more than one linear homopolycarbonate can be present. For example, the linear homopolycarbonate can comprise a bisphenol A homopolycarbonate having a weight average molecular weight of 15,000 to 25,000 g/mol or 17,000 to 23,000 g/mol or 18,000 to 22,000 g/mol, and a bisphenol A homopolycarbonate having a weight average molecular weight of 26,000 to 40,000 g/mol or 26,000 to 35,000 g/mol, each measured by GPC according to polystyrene standards and calculated for polycarbonate. The weight ratio of the linear homopolycarbonates relative to one another is 10:1 to 1:10, preferably 5:1 to 1:5, more preferably 3:1 to 1:3, or 2:1 to 1:2.

In addition to a linear homopolycarbonate, the polycarbonate compositions can include a styrene-containing copolymer in combination with the linear homopolycarbonate. The styrene-containing copolymer comprises an elastomeric phase including (i) butadiene and having a Tg of less than about 10° C., and (ii) a rigid polymeric phase having a Tg of greater than about 15° C. and including a copolymer of a monovinylaromatic monomer including styrene and an unsaturated nitrile such as acrylonitrile. The styrene-containing copolymer can include monovinylaromatic monomers other than styrene. Such styrene-containing copolymers may be prepared by first providing the elastomeric polymer, then polymerizing the constituent monomers of the rigid phase in the presence of the elastomer to obtain the graft copolymer. The grafts may be attached as graft branches or as shells to an elastomer core. The shell may merely physically encapsulate the core, or the shell may be partially or essentially completely grafted to the core.

Polybutadiene homopolymer may be used as the elastomer phase. Alternatively, the elastomer phase of the styrene-containing copolymer comprises butadiene copolymerized with up to about 25 wt % of another conjugated diene monomer of formula (8):

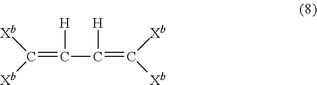

wherein each X^{b} is independently C₁-C₅ alkyl. Examples of conjugated diene monomers that may be used are isoprene, 1,3-heptadiene, methyl-1,3-pentadiene, 2,3-dimethyl-1,3-butadiene, 2-ethyl-1,3-pentadiene; 1,3- and 2,4-hexadienes, and the like, as well as mixtures including at least one of the foregoing conjugated diene monomers. A specific conjugated diene is isoprene.

The elastomeric butadiene phase may additionally be copolymerized with up to 25 wt %, preferably up to about 15 wt %, of another comonomer, for example monovinylaromatic monomers containing condensed aromatic ring structures such as vinyl naphthalene, vinyl anthracene and the like, or monomers of formula (9):

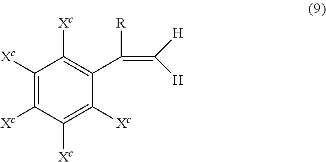

wherein each X^{c} is independently hydrogen, C₁-C₁₂ alkyl, C₃-C₁₂ cycloalkyl, C₆-C₁₂ aryl, C₇-C₁₂ aralkyl, C₇-C₁₂ alkaryl, C₁-C₁₂ alkoxy, C₃-C₁₂ cycloalkoxy, C₆-C₁₂ aryloxy, chloro, bromo, or hydroxy, and R is hydrogen, C₁-C₅ alkyl, bromo, or chloro. Examples of suitable monovinylaromatic monomers copolymerizable with the butadiene include styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, and the like, and combinations including at least one of the foregoing monovinylaromatic monomers. In one aspect, the butadiene is copolymerized with up to about 12 wt %, preferably about 1 to about 10 wt % styrene and/or alpha-methyl styrene.

Other monomers that may be copolymerized with the butadiene are monovinylic monomers such as itaconic acid, acrylamide, N-substituted acrylamide or methacrylamide, maleic anhydride, maleimide, N-alkyl-, aryl-, or haloaryl-substituted maleimide, glycidyl (meth)acrylates, and monomers of the generic formula (10):

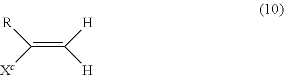

wherein R is hydrogen, C₁-C₅ alkyl, bromo, or chloro, and X^{c} is cyano, C₁-C₁₂ alkoxycarbonyl, C₁-C₁₂ aryloxycarbonyl, hydroxy carbonyl, and the like. Examples of monomers of formula (10) include acrylonitrile, ethacrylonitrile, methacrylonitrile, alpha-chloroacrylonitrile, beta-chloroacrylonitrile, alpha-bromoacrylonitrile, acrylic acid, methyl (meth)acrylate, ethyl (meth)acrylate, n-butyl (meth)acrylate, t-butyl (meth)acrylate, n-propyl (meth)acrylate, isopropyl (meth)acrylate, 2-ethylhexyl (meth)acrylate, and the like, and combinations including at least one of the foregoing monomers. Monomers such as n-butyl acrylate, ethyl acrylate, and 2-ethylhexyl acrylate are commonly used as monomers copolymerizable with the butadiene.

The particle size of the butadiene phase is not limited, and may be, for example about 0.01 to about 20 micrometers, preferably about 0.5 to about 10 micrometers, more preferably about 0.6 to about 1.5 micrometers may be used for bulk polymerized rubber substrates. Particle size may be measured by light transmission methods or capillary hydrodynamic chromatography (CHDF). The butadiene phase may provide about 5 to about 95 wt % of the total weight of the styrene-containing copolymer, more preferably about 20 to about 90 wt %, and even more preferably about 40 to about 85 wt % of the styrene-containing copolymer, the remainder being the rigid graft phase.

The rigid graft phase comprises a copolymer formed from a styrenic monomer composition together with an unsaturated monomer including a nitrile group. As used herein, “styrenic monomer” includes monomers of formula (9) wherein each X^{c} is independently hydrogen, C₁-C₄ alkyl, phenyl, C₇-C₉ aralkyl, C₇-C₉ alkaryl, C₁-C₄ alkoxy, phenoxy, chloro, bromo, or hydroxy, and R is hydrogen, C₁-C₂ alkyl, bromo, or chloro. Specific examples styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, and the like. Combinations including at least one of the foregoing styrenic monomers may be used.

Further as used herein, an unsaturated monomer including a nitrile group includes monomers of formula (10) wherein R is hydrogen, C₁-C₅ alkyl, bromo, or chloro, and X^{c} is cyano. Specific examples include acrylonitrile, ethacrylonitrile, methacrylonitrile, alpha-chloroacrylonitrile, beta-chloroacrylonitrile, alpha-bromoacrylonitrile, and the like. Combinations including at least one of the foregoing monomers may be used.

The rigid graft phase of the styrene-containing copolymer may further optionally comprise other monomers copolymerizable therewith, including other monovinylaromatic monomers and/or monovinylic monomers such as itaconic acid, acrylamide, N-substituted acrylamide or methacrylamide, maleic anhydride, maleimide, N-alkyl-, aryl-, or haloaryl-substituted maleimide, glycidyl (meth)acrylates, and monomers of the generic formula (10). Specific comonomers include C₁-C₄ alkyl (meth)acrylates, for example methyl methacrylate.

The rigid copolymer phase generally comprises about 10 to about 99 wt %, preferably about 40 to about 95 wt %, more preferably about 50 to about 90 wt % of the styrenic monomer; about 1 to about 90 wt %, preferably about 10 to about 80 wt %, more preferably about 10 to about 50 wt % of the unsaturated monomer including a nitrile group: and 0 to about 25 wt %, preferably 1 to about 15 wt % of other comonomer, each based on the total weight of the rigid copolymer phase.

The styrene-containing copolymer may further comprise a separate matrix or continuous phase of ungrafted rigid copolymer that may be simultaneously obtained with the styrene-containing copolymer. The styrene-containing copolymer may comprise about 40 to about 95 wt % elastomer-modified graft copolymer and about 5 to about 65 wt % rigid copolymer, based on the total weight of the styrene-containing copolymer. In another aspect, the styrene-containing copolymer may comprise about 50 to about 85 wt %, more preferably about 75 to about 85 wt % elastomer-modified graft copolymer, together with about 15 to about 50 wt %, more preferably about 15 to about 25 wt % rigid copolymer, based on the total weight of the styrene-containing copolymer.

A variety of bulk polymerization methods for styrene-containing copolymer resins are known. In multizone plug flow bulk processes, a series of polymerization vessels (or towers), consecutively connected to each other, providing multiple reaction zones. The elastomeric butadiene may be dissolved in one or more of the monomers used to form the rigid phase, and the elastomer solution is fed into the reaction system. During the reaction, which may be thermally or chemically initiated, the elastomer is grafted with the rigid copolymer (e.g., SAN). Bulk copolymer (referred to also as free copolymer, matrix copolymer, or non-grafted copolymer) is also formed within the continuous phase containing the dissolved rubber. As polymerization continues, domains of free copolymer are formed within the continuous phase of rubber/comonomers to provide a two-phase system. As polymerization proceeds and more free copolymer is formed, the elastomer-modified copolymer starts to disperse itself as particles in the free copolymer and the free copolymer becomes a continuous phase (phase inversion). Some free copolymer is generally occluded within the elastomer-modified copolymer phase as well. Following the phase inversion, additional heating may be used to complete polymerization. Numerous modifications of this basis process have been described, for example in U.S. Pat. No. 3,511,895, which describes a continuous bulk ABS process that provides controllable molecular weight distribution and microgel particle size using a three-stage reactor system. In the first reactor, the elastomer/monomer solution is charged into the reaction mixture under high agitation to precipitate discrete rubber particle uniformly throughout the reactor mass before appreciable cross-linking can occur. Solids levels of the first, the second, and the third reactor are carefully controlled so that molecular weights fall into a desirable range. U.S. Pat. No. 3,981,944 discloses extraction of the elastomer particles using the styrenic monomer to dissolve/disperse the elastomer particles, prior to addition of the unsaturated monomer including a nitrile group and any other comonomers. U.S. Pat. No. 5,414,045 discloses reacting in a plug flow grafting reactor a liquid feed composition including a styrenic monomer composition, an unsaturated nitrile monomer composition, and an elastomeric butadiene polymer to a point prior to phase inversion, and reacting the first polymerization product (grafted elastomer) therefrom in a continuous-stirred tank reactor to yield a phase inverted second polymerization product that then can be further reacted in a finishing reactor, and then devolatilized to produce the desired final product.

The linear homopolycarbonate or the linear homopolycarbonate and the styrene-containing copolymer can be present in an amount of about 10 to about 99 wt %, based on the total weight of the polycarbonate composition. Within this range, the linear homopolycarbonate or the combination of the linear homopolycarbonate and the styrene-containing copolymer can be present in an amount of about 50 to about 99 wt %, or about 60 to about 95 wt %, or about 65 to about 95 wt %, or about 70 to about 95 wt %.

In addition to a linear homopolycarbonate or the combination of a linear homopolycarbonate and a styrene-containing copolymer, a poly(carbonate-siloxane) including a siloxane content of about 10 to less than about 30 wt % is present in the polycarbonate compositions. As used herein, “siloxane content” of a poly(carbonate-siloxane) refers to the content of siloxane units based on the total weight of the polycarbonate composition. Within this range, the poly(carbonate-siloxane) copolymer can have a siloxane content of about 15 to about 25 wt %.

The polysiloxane blocks of the poly(carbonate-siloxane)s comprise repeating diorganosiloxane units as in formula (10)

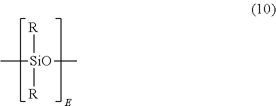

wherein each R is independently a C₁₋₁₃ monovalent organic group. For example, R can be a C₁₋₁₃ alkyl, C₁₋₁₃ alkoxy, C₂₋₁₃ alkenyl, C₂₋₁₃ alkenyloxy, C₃₋₆ cycloalkyl, C₃₋₆ cycloalkoxy, C₆₋₁₄ aryl, C₆₋₁₀ aryloxy, C₇₋₁₃ arylalkylene, C₇₋₁₃ arylalkylenoxy, C₇₋₁₃ alkylarylene, or C₇₋₁₃ alkylaryleneoxy. The foregoing groups can be fully or partially halogenated with fluorine, chlorine, bromine, or iodine, or a combination thereof. In an aspect, where a transparent poly(carbonate-siloxane) is desired, R is unsubstituted by halogen. Combinations of the foregoing R groups can be used in the same copolymer. The polysiloxane blocks of the poly(carbonate-siloxane)s can be substantially free of or exclude hydride-functionalized siloxane repeating units. Referring to formula (10), hydride-functionalized siloxane repeating units have a hydrogen in at least one position corresponding to R. “Substantially free of hydride-functionalized siloxane repeating units” as used herein means 1 wt % or less, 0.1 wt % or less, or 0.01 wt % or less of hydride-functionalized siloxane repeating units, based on the total weight of the poly(carbonate-siloxane).

The value of E in formula (10) can vary widely depending on the type and relative amount of each component in the polycarbonate composition, the desired properties of the composition, and like considerations. Generally, E has an average value of 2 to 1,000, preferably 2 to 500, 2 to 200, or 2 to 125, 5 to 80, or 10 to 70. In an aspect, E has an average value of 10 to 80 or 10 to 40, and in still another aspect, E has an average value of 40 to 80, or 40 to 70. Where E is of a lower value, e.g., less than 40, it can be desirable to use a relatively larger amount of the poly(carbonate-siloxane) copolymer. Conversely, where E is of a higher value, e.g., greater than 40, a relatively lower amount of the poly(carbonate-siloxane) copolymer can be used. A combination of a first and a second (or more) poly(carbonate-siloxane) copolymers can be used, wherein the average value of E of the first copolymer is less than the average value of E of the second copolymer.

In an aspect, the polysiloxane blocks are of formula (11)

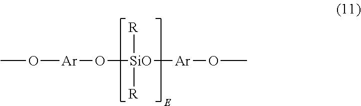

wherein E and R are as defined if formula (10); each R can be the same or different, and is as defined above; and Ar can be the same or different, and is a substituted or unsubstituted C₆₋₃₀ arylene, wherein the bonds are directly connected to an aromatic moiety. Ar groups in formula (11) can be derived from a C₆₋₃₀ dihydroxyarylene compound, for example a dihydroxyarylene compound of formula (3) or (6). Dihydroxyarylene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulfide), and 1,1-bis(4-hydroxy-t-butylphenyl) propane.

In another aspect, polysiloxane blocks are of formula (13)

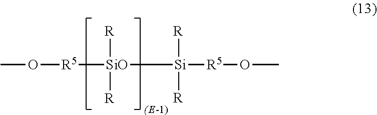

wherein R and E are as described above, and each R⁵ is independently a divalent C₁₋₃₀ organic group, and wherein the polymerized polysiloxane unit is the reaction residue of its corresponding dihydroxy compound. In a specific aspect, the polysiloxane blocks are of formula (14):

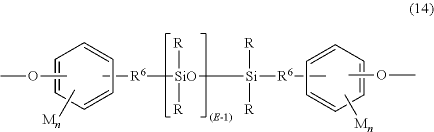

wherein R and E are as defined above. R⁶ in formula (14) is a divalent C₂₋₈ aliphatic group. Each M in formula (14) can be the same or different, and can be a halogen, cyano, nitro, C₁₋₈ alkylthio, C₁₋₈ alkyl, C₁₋₈ alkoxy, C₂₋₈ alkenyl, C₂₋₈ alkenyloxy, C₃₋₈ cycloalkyl, C₃₋₈ cycloalkoxy, C₆₋₁₀ aryl, C₆₋₁₀ aryloxy, C₇₋₁₂ aralkyl, C₇₋₁₂ aralkoxy, C₇₋₁₂ alkylaryl, or C₇₋₁₂ alkylaryloxy, wherein each n is independently 0, 1, 2, 3, or 4.

In an aspect, M is bromo or chloro, an alkyl such as methyl, ethyl, or propyl, an alkoxy such as methoxy, ethoxy, or propoxy, or an aryl such as phenyl, chlorophenyl, or tolyl; R⁶ is a dimethylene, trimethylene or tetramethylene; and R is a C₁₋₈ alkyl, haloalkyl such as trifluoropropyl, cyanoalkyl, or aryl such as phenyl, chlorophenyl or tolyl. In another aspect, R is methyl, or a combination of methyl and trifluoropropyl, or a combination of methyl and phenyl. In still another aspect, R is methyl, M is methoxy, n is one, and R⁶ is a divalent C₁₋₃ aliphatic group. Specific polysiloxane blocks are of the formula

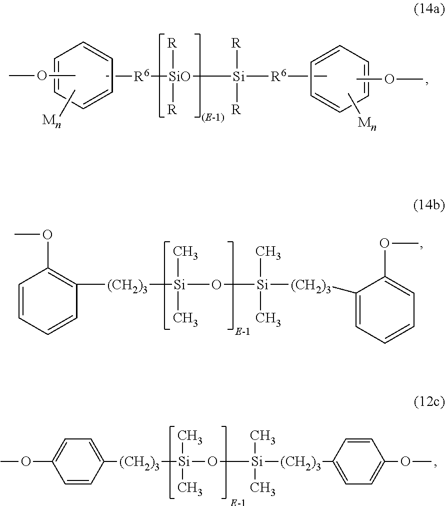

or a combination thereof, wherein E has an average value of 2 to 200, 2 to 125, 5 to 125, 5 to 100, 5 to 50, 20 to 80, or 5 to 20.

Blocks of formula (14) can be derived from the corresponding dihydroxy polysiloxane, which in turn can be prepared effecting a platinum-catalyzed addition between the siloxane hydride and an aliphatically unsaturated monohydric phenol such as eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. The poly(carbonate-siloxane) copolymers can then be manufactured, for example, by the synthetic procedure of European Patent Application Publication No. 0 524 731 A1 of Hoover, page 5, Preparation 2.

Transparent poly(carbonate-siloxane) copolymers comprise carbonate units (1) derived from bisphenol A, and repeating siloxane units (14a), (14b), (14c), or a combination thereof (preferably of formula 14a), wherein E has an average value of 4 to 50, 4 to 15, preferably 5 to 15, more preferably 6 to 15, and still more preferably 7 to 10. The transparent copolymers can be manufactured using one or both of the tube reactor processes described in U.S. Patent Application No. 2004/0039145A1 or the process described in U.S. Pat. No. 6,723,864 can be used to synthesize the poly(carbonate-siloxane) copolymers.

In an aspect, a blend is used, in particular a blend of a bisphenol A homopolycarbonate and a poly(carbonate-siloxane) block copolymer of bisphenol A blocks and eugenol capped polydimethylsiloxane blocks, of the formula

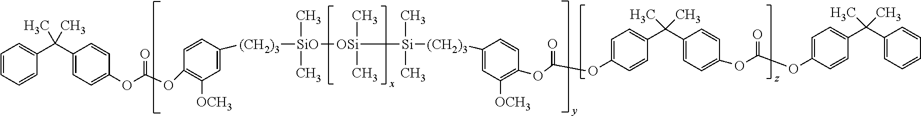

wherein x is 1 to 200, preferably 5 to 85, preferably 10 to 70, preferably 15 to 65, and more preferably 40 to 60: x is 1 to 500, or 10 to 200, and z is 1 to 1000, or 10 to 800. In an aspect, x is 1 to 200, y is 1 to 90 and z is 1 to 600, and in another aspect, x is 30 to 50, y is 10 to 30 and z is 45 to 600. The polysiloxane blocks can be randomly distributed or controlled distributed among the polycarbonate blocks.

In an aspect, the polycarbonate compositions can include a poly(carbonate-siloxane) including a siloxane content of less than about 10 wt % or less, preferably about 6 wt % or less, and more preferably about 4 wt % or less, of the polysiloxane based on the total weight of the poly(carbonate-siloxane) copolymer. In some aspects, the polycarbonate compositions can exclude a poly(carbonate-siloxane) including a siloxane content of less than 10 wt %.

The poly(carbonate-siloxane)s can have a weight average molecular weight of 2,000 to 100,000 grams per mole (g/mol), preferably 5,000 to 50,000 g/mol as measured by gel permeation chromatography using a crosslinked styrene-divinyl benzene column, at a sample concentration of 1 milligram per milliliter, measured according to polystyrene standards and calculated for polycarbonate. In some aspects, the poly(carbonate-siloxane) having a siloxane content of 30 to 70 wt % and the poly(carbonate-siloxane) having a siloxane content of 10 to less than 30 wt % can each have a weight average molecular weight of at least 25,000 g/mol, preferably 27,000 g/mol. Within this range, the poly(carbonate-siloxane)s can have a weight average molecular weight of 25,000 to 100,000 g/mol. The poly(carbonate-siloxane) having a siloxane content of 30 to 70 wt % preferably can have a weight average molecular weight of greater than 21,000 g/mol, more preferably greater than 25,000g/mol. When the weight average molecular weight of the poly(carbonate-siloxane) having a siloxane content of 30 to 70 wt % is within these ranges, delamination of molded samples can be avoided. The poly(carbonate-siloxane) having a siloxane content of 30 to 70 wt % can have weight average molecular weight greater than 30,000 to less than 50,000 g/mol. When the weight average molecular weight of the poly(carbonate-siloxane) having a siloxane content of 30 to 70 wt % is within this range, processability and chemical resistance can be improved.

The poly(carbonate-siloxane) having a siloxane content of 10 to less than 30 wt % can have a weight average molecular weight of 25,000 to 40,000 g/mol, more preferably 27,000 to 32,000 g/mol as measured by gel permeation chromatography using a crosslinked styrene-divinyl benzene column, at a sample concentration of 1 milligram per milliliter, according to polystyrene standards and calculated for polycarbonate.

In an aspect, the composition comprises less than or equal to about 5 wt % or less than or equal to about 1 wt %, or less than or equal to about 0.1 wt % of a poly(carbonate-siloxane) including a siloxane content of less than about 10 wt %. A poly(carbonate-siloxane) including a siloxane content of less than about 10 wt % may be excluded from the composition. Preferably, a poly(carbonate-siloxane) including a siloxane content of about 6 wt % may be excluded from the composition.

The poly(carbonate-siloxane) having a siloxane content of about 10 to less than about 30 wt % may be present in an amount effective to provide about 1 to about 6 wt %, or about 3 to about 6 wt % siloxane, based on the total weight of the polycarbonate composition.

The poly(carbonate-siloxane)s can have a melt volume flow rate, measured at 300° C./1.2 kg, of 1 to 50 cubic centimeters per 10 minutes (cc/10 min), preferably 2 to 30 cc/10 min. Combinations of the poly(carbonate-siloxane)s of different flow properties can be used to achieve the overall desired flow property.

The polycarbonate compositions include an ultra-high molecular weight (UHMW) polydimethylsiloxane. In some aspects, one or more of the two methyl groups on each siloxane repeating unit may be replaced with other functional groups to influence compatibility within a given composition.

The number of repeating units in the UHMW polydimethylsiloxanes may range up to several thousand, which accounts for molecular weights as high as one million g/mol. The UMHW polydimethylsiloxane can have a weight average molecular weight of at least 100,000 g/mol or at least 120,000 g/mol according to a GPC method using polystyrene standards. The UMHW polydimethylsiloxane can be included as a masterbatch (MB) in a carrier resin. The carrier resin is not particularly limited and can include any thermoplastic polymer, as long as the thermoplastic polymer is compatible with the polycarbonate composition. In some aspects, the carrier resin is polycarbonate. UMHW polydimethylsiloxane as a MB in polycarbonate (30 wt %) is available as PEARLENE, MB01, from Momentive Performance Materials.

The UHMW polydimethylsiloxane is present in amount effective to provide a siloxane content of greater than about 0.3 to less than about 0.9 wt %, or greater than about 0.3 to less than about 0.75 wt %, each based on the total weight of the polycarbonate composition. When the amount of UHMW polydimethylsiloxane exceeds an amount effective to provide a siloxane content of about 0.9 wt %, then aesthetic problems such as gate blush and surface imperfections can arise.

The siloxane content of the composition provided by the poly(carbonate-siloxane) having a siloxane content of about 10 to less than about 30 wt % is greater than the siloxane content provided by the UHMW polydimethylsiloxane. The weight ratio of the siloxane provided by the poly(carbonate-siloxane) having a siloxane content of about 10 to less than about 30 wt % to the siloxane provided by the UHMW polydimethylsiloxane can be greater than about 1:1, or at least about 2:1, or at least about 3:1, or at least about 4:1, or at least about 5:1.

The polycarbonate compositions include a flame retardant. The flame retardant can include halogenated flame retardants, provided that the halogen content of the compositions is within the guidelines as set-forth by IEC 61249-2-21 and/or UL 746H. According to both IEC 61249-2-21 and UL 746H, the bromine and chlorine content are each 900 ppm or less and the total bromine, chlorine, and fluorine content of the polycarbonate composition is 1500 ppm or less. UL 746H has the additional requirement that the fluorine content of the composition be 900 ppm or less. These values can be calculated or determined by elemental analysis techniques.

Halogenated flame retardants can include halogenated compounds and polymers of formula (20):

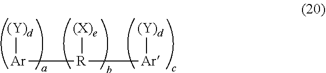

wherein R is an alkylene, alkylidene, or cycloaliphatic linkage (e.g., methylene, ethylene, propylene, isopropylene, isopropylidene, butylene, isobutylene, amylene, cyclohexylene, cyclopentylidene, and the like), a linkage selected from oxygen ether, carbonyl, amine, a sulfur containing linkage (e.g., sulfide, sulfoxide, or sulfone), a phosphorus containing linkage, and the like, or R can also consist of two or more alkylene or alkylidene linkages connected by such groups as aromatic, amino, ether, carbonyl, sulfide, sulfoxide, sulfone, a phosphorus containing linkage, and the like; Ar and Ar′ can be the same or different and are mono- or polycarbocyclic aromatic groups such as phenylene, biphenylene, terphenylene, naphthylene, and the like; Y is an organic, inorganic or organometallic radical such as halogen (e.g., chlorine, bromine, iodine, or fluorine), ether group of the general formula OE wherein E is a monovalent hydrocarbon radical similar to X, monovalent hydrocarbon groups of the type represented by R, or other substituents (e.g., nitro, cyano, or the like), the substituents being essentially inert provided there be at least one and preferably two halogen atoms per aryl nucleus; each X is the same or different, and is a monovalent hydrocarbon group such as alkyl (e.g., methyl, ethyl, propyl, isopropyl, butyl, decyl, and the like, aryl ((e.g., phenyl, naphthyl, biphenyl, xylyl, tolyl, and the like), arylalkylene (e.g., as benzyl, ethylenephenyl, and the like), cycloaliphatic (e.g., cyclopentyl, cyclohexyl, and the like), as well as monovalent hydrocarbon groups containing inert substituents therein; the letter d represents a whole number from 1 to a maximum equivalent to the number of replaceable hydrogens substituted on the aromatic rings including Ar or Ar′; the letter e represents a whole number from 0 to a maximum equivalent to the number of replaceable hydrogens on R; the letters a, b, and c represent whole numbers including 0, provided that when b is not 0, neither a nor c can be 0,or that either a or c, but not both, can be 0, or that where b is 0, the aromatic groups are joined by a direct carbon-carbon bond; the hydroxyl and Y substituents on the aromatic groups, Ar and Ar′ can be varied in the ortho, meta or para positions on the aromatic rings and the groups can be in any possible geometric relationship with respect to one another.

Included within the scope of the above formula are bisphenols of which the following are representative: 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; 2,2-bis-(2,6-dichlorophenyl)-pentane; 2,2-bis-(3,5-dibromophenyl)-hexane; bis-(4-chlorophenyl)-phenyl-methane; bis-(3,5-dichlorophenyl)-cyclohexylmethane; bis-(3-nitro-4-bromophenyl)-methane; bis-(4-hydroxy-2,6-dichloro-3-methoxyphenyl)-methane; and 2,2-bis-(3,5-dichloro-4-hydroxyphenyl)-propane 2,2 bis-(3-bromo-4-hydroxyphenyl)-propane. Also included within the above structural formula are: 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, and the like.

Also useful are oligomeric and polymeric halogenated aromatic compounds, such as a copolycarbonate of bisphenol A and tetrabromobisphenol A and a carbonate precursor, e.g., phosgene. Metal synergists, e.g., antimony oxide, can also be used with the flame retardant.

Inorganic flame retardants can also be used, for example salts of C₂₋₁₆ alkyl sulfonates such as potassium perfluorobutane sulfonate (Rimar salt), potassium perfluoroctane sulfonate, and tetraethylammonium perfluorohexane sulfonate, salts of aromatic sulfonates such as sodium benzene sulfonate, sodium toluene sulfonate (NATS), and the like, salts of aromatic sulfone sulfonates such as potassium diphenylsulfone sulfonate (KSS), and the like; salts formed by reacting for example an alkali metal or alkaline earth metal (e.g., lithium, sodium, potassium, magnesium, calcium and barium salts) and an inorganic acid complex salt, for example, an oxo-anion (e.g., alkali metal and alkaline-earth metal salts of carbonic acid, such as Na₂CO₃, K₂CO₃, MgCO₃, CaCO₃, and BaCO₃, or a fluoro-anion complex such as Li₃AlF₆, BaSiF₆, KBF₄, K₃AlF₆, KAlF₄, K₂SiF₆, or Na₃AlF₆ or the like. Rimar salt and KSS and NATS, alone or in combination with other flame retardants, are particularly useful. Rimar salt and KSS and NATS, alone or in combination with other flame retardants, are particularly useful.

Di- or polyfunctional aromatic phosphorous-containing compounds are also useful, for example, compounds of formula (14)

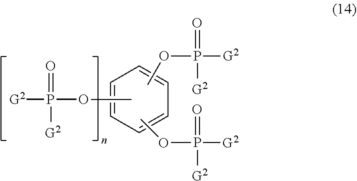

wherein each G² is independently a hydrocarbyl or hydrocarbyoxy having 1 to 30 carbon atoms, and n is 0 to 3.

Specific aromatic organophosphorous compounds have two or more phosphorous-containing groups, and are inclusive of acid esters of formula (15)

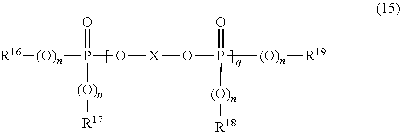

wherein R¹⁶, R¹⁷, R¹⁸, and R¹⁹ are each independently C₁₋₈ alkyl, C₅₋₆ cycloalkyl, C₆₋₂₀ aryl, or C₇₋₁₂ arylalkylene, each optionally substituted by C₁₋₁₂ alkyl, preferably by C₁₋₄ alkyl and X is a mono- or poly-nuclear aromatic C₆₋₃₀ moiety or a linear or branched C₂₋₃₀ aliphatic radical, which can be OH-substituted and can contain up to 8 ether bonds, provided that at least one of R¹⁶, R¹⁷, R¹⁸, R¹⁹, and X is an aromatic group. In some aspects R¹⁶, R¹⁷, R¹⁸, and R¹⁹ are each independently C₁₋₄ alkyl, naphthyl, phenyl(C₁₋₄)alkylene, or aryl groups optionally substituted by C₁₋₄ alkyl. Specific aryl moieties are cresyl, phenyl, xylenyl, propylphenyl, or butylphenyl. In some aspects X in formula (15) is a mono- or poly-nuclear aromatic C₆₋₃₀ moiety derived from a diphenol. Further in formula (15), n is each independently 0 or 1; in some aspects n is equal to 1. Also in formula (15), q is from 0.5 to 30, from 0.8 to 15, from 1 to 5, or from 1 to 2. Preferably, X can be represented by the following divalent groups (16), or a combination thereof.

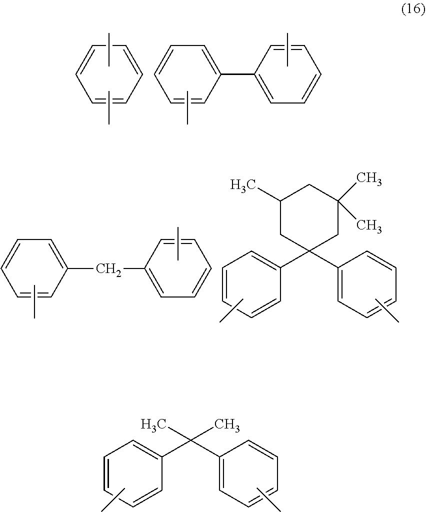

In these aspects, each of R¹⁶, R¹⁷, R¹⁸, and R¹⁹ can be aromatic, i.e., phenyl, n is 1, and p is 1-5, preferably 1-2. In some aspects at least one of R¹⁶, R¹⁷, R¹⁸, R¹⁹, and X corresponds to a monomer used to form the polycarbonate, e.g., bisphenol A or resorcinol. In another aspect, X is derived especially from resorcinol, hydroquinone, bisphenol A, or diphenylphenol, and R¹⁶, R¹⁷, R¹⁸, R¹⁹, is aromatic, preferably phenyl. A specific aromatic organophosphorous compound of this type is resorcinol bis(diphenyl phosphate), also known as RDP. Another specific class of aromatic organophosphorous compounds having two or more phosphorous-containing groups are compounds of formula (17)

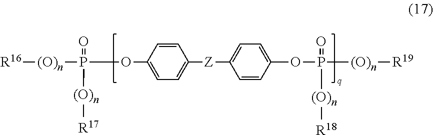

wherein R¹⁶, R¹⁷, R¹⁸, R¹⁹, n, and q are as defined for formula (19) and wherein Z is C₁₋₇ alkylidene, C₁₋₇ alkylene, C₃₋₁₂ cycloalkylidene, —O—, —S—, —SO₂—, or —CO—, preferably isopropylidene. A specific aromatic organophosphorous compound of this type is bisphenol A bis(diphenyl phosphate), also known as BPADP, wherein R¹⁶, R¹⁷, R¹⁸, and R¹⁹ are each phenyl, each n is 1, and q is from 1 to 5, from 1 to 2, or 1.

Flame retardant compounds containing phosphorous-nitrogen bonds include phosphazenes, phosphonitrilic chloride, phosphorous ester amides, phosphoric acid amides, phosphonic acid amides, phosphinic acid amides, and tris(aziridinyl) phosphine oxide. Specific examples include phosphoramides of the formula

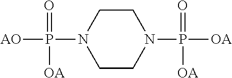

wherein each A moiety is a 2,6-dimethylphenyl moiety or a 2,4,6-trimethylphenyl moiety. These phosphoramides are piperazine-type phosphoramides.

Phosphazenes (18) and cyclic phosphazenes (19)

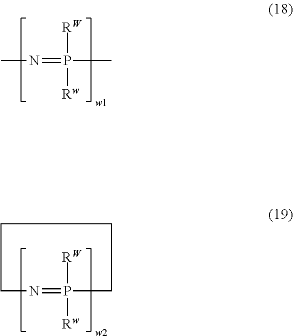

in particular can be used, wherein w1 is 3 to 10,000 and w2 is 3 to 25, preferably 3 to 7, and each R^{w} is independently a C₁₋₁₂ alkyl, alkenyl, alkoxy, aryl, aryloxy, or polyoxyalkylene group. In the foregoing groups at least one hydrogen atom of these groups can be substituted with a group having an N, S, O, or F atom, or an amino group. For example, each R^{w} can be a substituted or unsubstituted phenoxy, an amino, or a polyoxyalkylene group. Any given R^{w} can further be a crosslink to another phosphazene group. Exemplary crosslinks include bisphenol groups, for example bisphenol A groups. Examples include phenoxy cyclotriphosphazene, octaphenoxy cyclotetraphosphazene decaphenoxy cyclopentaphosphazene, and the like. A combination of different phosphazenes can be used. A number of phosphazenes and their synthesis are described in H. R. Allcook, “Phosphorous-Nitrogen Compounds” Academic Press (1972), In the aromatic organophosphorous compounds that have at least one organic aromatic group, the aromatic group can be a substituted or unsubstituted C₃₋₃₀ group containing one or more of a monocyclic or polycyclic aromatic moiety (which can optionally contain with up to three heteroatoms (N, O, P, S, or Si)) and optionally further containing one or more nonaromatic moieties, for example alkyl, alkenyl, alkynyl, or cycloalkyl. The aromatic moiety of the aromatic group can be directly bonded to the phosphorous-containing group, or bonded via another moiety, for example an alkylene group. The aromatic moiety of the aromatic group can be directly bonded to the phosphorous-containing group, or bonded via another moiety, for example an alkylene group. In an aspect the aromatic group is the same as an aromatic group of the polycarbonate backbone, such as a bisphenol group (e.g., bisphenol A), a monoarylene group (e.g., a 1,3-phenylene or a 1,4-phenylene), or a combination including at least one of the foregoing.

The phosphorous-containing group can be a phosphate (P(═O)(OR)₃), phosphite (P(OR)₃), phosphonate (RP(═O)(OR)₂), phosphinate (R₂P(═O)(OR)), phosphine oxide (R₃P(═O)), or phosphine (R₃P), wherein each R in the foregoing phosphorous-containing groups can be the same or different, provided that at least one R is an aromatic group. A combination of different phosphorous-containing groups can be used. The aromatic group can be directly or indirectly bonded to the phosphorous, or to an oxygen of the phosphorous-containing group (i.e., an ester).

In an aspect the aromatic organophosphorous compound is a monomeric phosphate. Representative monomeric aromatic phosphates are of the formula (GO)₃P═O, wherein each G is independently an alkyl, cycloalkyl, aryl, alkylarylene, or arylalkylene group having up to 30 carbon atoms, provided that at least one G is an aromatic group. Two of the G groups can be joined together to provide a cyclic group. In some aspects G corresponds to a monomer used to form the polycarbonate, e.g., resorcinol. Exemplary phosphates include phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, and the like. A specific aromatic phosphate is one in which each G is aromatic, for example, triphenyl phosphate, tricresyl phosphate, isopropylated triphenyl phosphate, and the like.

Di- or polyfunctional aromatic organophosphorous compounds are also useful, for example compounds of the formulas

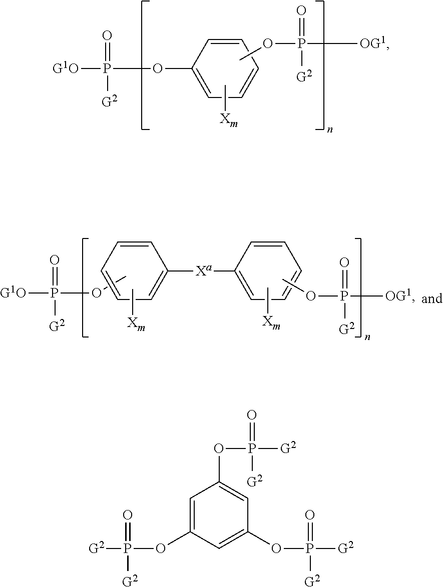

wherein each G¹ is independently a C₁₋₃₀ hydrocarbyl; each G² is independently a C₁₋₃₀ hydrocarbyl or hydrocarbyloxy; X^{a} is as defined in formula (3) or formula (4); each X is independently a bromine or chlorine; m is 0 to 4, and n is 1 to 30. In a specific aspect, X^{a} is a single bond, methylene, isopropylidene, or 3,3,5-trimethylcyclohexylidene.

Specific aromatic organophosphorous compounds are inclusive of acid esters of formula (9)

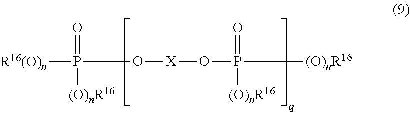

wherein each R¹⁶ is independently C₁₋₈ alkyl, C₅₋₆ cycloalkyl, C₆₋₂₀ aryl, or C₇₋₁₂ arylalkylene, each optionally substituted by C₁₋₁₂ alkyl, specifically by C₁₋₄ alkyl and X is a mono- or poly-nuclear aromatic C₆₋₃₀ moiety or a linear or branched C₂₋₃₀ aliphatic radical, which can be OH-substituted and can contain up to 8 ether bonds, provided that at least one R¹⁶ or X is an aromatic group; each n is independently 0 or 1; and q is from 0.5 to 30. In some aspects each R¹⁶ is independently C₁₋₄ alkyl, naphthyl, phenyl(C₁₋₄)alkylene, aryl groups optionally substituted by C₁₋₄ alkyl; each X is a mono- or poly-nuclear aromatic C₆₋₃₀ moiety, each n is 1; and q is from 0.5 to 30. In some aspects each R¹⁶ is aromatic, e.g., phenyl; each X is a mono- or poly-nuclear aromatic C₆₋₃₀ moiety, including a moiety derived from formula (2); n is one; and q is from 0.8 to 15. In other aspects, each R¹⁶ is phenyl; X is cresyl, xylenyl, propylphenyl, or butylphenyl, one of the following divalent groups

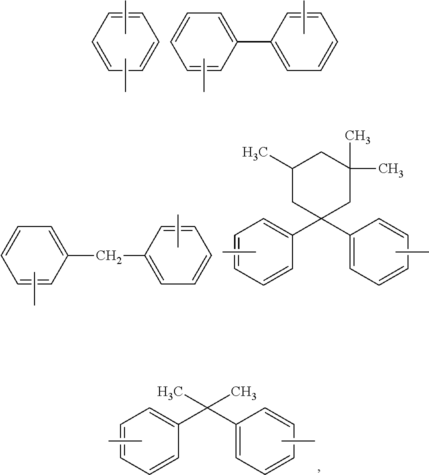

or a combination including one or more of the foregoing; n is 1; and q is from 1 to 5, or from 1 to 2. In some aspects at least one R¹⁶ or X corresponds to a monomer used to form the polycarbonate, e.g., bisphenol A, resorcinol, or the like. Aromatic organophosphorous compounds of this type include the bis(diphenyl) phosphate of hydroquinone, resorcinol bis(diphenyl phosphate) (RDP), and bisphenol A bis(diphenyl) phosphate (BPADP), and their oligomeric and polymeric counterparts.

The organophosphorous flame retardant containing a phosphorous-nitrogen bond can be a phosphazene, phosphonitrilic chloride, phosphorous ester amide, phosphoric acid amide, phosphonic acid amide, phosphinic acid amide, or tris(aziridinyl) phosphine oxide. These flame-retardant additives are commercially available. In an aspect, the organophosphorous flame retardant containing a phosphorous-nitrogen bond is a phosphazene or cyclic phosphazene of the formulas

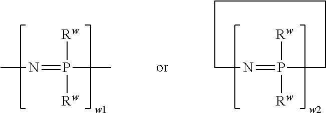

wherein w1 is 3 to 10,000; w2 is 3 to 25, or 3 to 7; and each R^{w} is independently a C₁₋₁₂ alkyl, alkenyl, alkoxy, aryl, aryloxy, or polyoxyalkylene group. In the foregoing groups at least one hydrogen atom of these groups can be substituted with a group having an N, S, O, or F atom, or an amino group. For example, each R^{w} can be a substituted or unsubstituted phenoxy, an amino, or a polyoxyalkylene group. Any given R^{w} can further be a crosslink to another phosphazene group. Exemplary crosslinks include bisphenol groups, for example bisphenol A groups. Examples include phenoxy cyclotriphosphazene, octaphenoxy cyclotetraphosphazene decaphenoxy cyclopentaphosphazene, and the like. In an aspect, the phosphazene has a structure represented by the formula

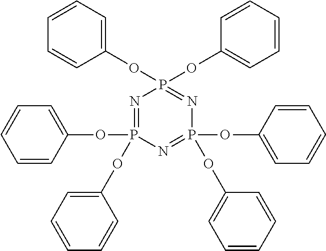 [SMILES: c1ccc(OP2(Oc3ccccc3)=NP(Oc3ccccc3)(Oc3ccccc3)=NP(Oc3ccccc3)(Oc3ccccc3)=N2)cc1]

Commercially available phenoxyphosphazenes having the aforementioned structures are LY202 manufactured and distributed by Lanyin Chemical Co., Ltd, FP-110 manufactured and distributed by Fushimi Pharmaceutical Co., Ltd, and SPB-100 manufactured and distributed by Otsuka Chemical Co., Ltd.

When present, phosphorous-containing flame retardants are generally present in an amount effective to provide up to 5 wt % phosphorous, based on the total weight of the composition. In addition, if halogenated, the phosphorous-containing flame retardants are generally present in an amount effective to provide about 900 ppm or less of each of bromine, chlorine, and optionally, fluorine, and about 1500 ppm or less of total halogen content (e.g., bromine, chlorine and fluorine), based on the total weight of the composition.

An additive composition can be used, including one or more additives selected to achieve a desired property, with the proviso that the additive(s) are also selected so as to not significantly adversely affect the flame retardance and anti-drip properties of the polycarbonate composition. The additive composition or individual additives can be mixed at a suitable time during the mixing of the components for forming the composition. The additive can be soluble or non-soluble in polycarbonate. The additive composition can include an impact modifier, flow modifier, filler (e.g., a particulate polytetrafluoroethylene (PTFE), glass, carbon, mineral, or metal), reinforcing agent (e.g., glass fibers), antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g. a dye or pigment), surface effect additive, radiation stabilizer, or a combination thereof. In some aspects, the additive composition can exclude fillers such as mineral fillers. For example, a combination of a heat stabilizer, mold release agent, and ultraviolet light stabilizer can be used. In general, the additives are used in the amounts generally known to be effective. For example, the total amount of the additive composition (other than any impact modifier, filler, or reinforcing agent) can be 0.001 to 10.0 wt %, or 0.01 to 5 wt %, each based on the total weight of the polymer in the composition.

Colorants such as pigment or dye additives can also be present. Useful pigments can include, for example, inorganic pigments such as metal oxides and mixed metal oxides such as zinc oxide, titanium dioxides, iron oxides, or the like; sulfides such as zinc sulfides, or the like; aluminates; sodium sulfo-silicates sulfates, chromates, or the like; carbon blacks; zinc ferrites; ultramarine blue; organic pigments such as azos, di-azos, quinacridones, perylenes, naphthalene tetracarboxylic acids, flavanthrones, isoindolinones, tetrachloroisoindolinones, anthraquinones, enthrones, dioxazines, phthalocyanines, and azo lakes; Pigment Red 101, Pigment Red 122, Pigment Red 149, Pigment Red 177, Pigment Red 179, Pigment Red 202, Pigment Violet 29, Pigment Blue 15, Pigment Blue 60, Pigment Green 7, Pigment Yellow 119, Pigment Yellow 147, Pigment Yellow 150, and Pigment Brown 24; or a combination thereof.

The polycarbonate compositions can be manufactured by various methods. For example, the powdered polycarbonates, flame retardant, or other optional components are first blended, optionally with fillers in a HENSCHEL-Mixer high speed mixer. Other low shear processes, including but not limited to hand mixing, can also accomplish this blending. The blend is then fed into the throat of a twin-screw extruder via a hopper. Alternatively, at least one of the components can be incorporated into the composition by feeding directly into the extruder at the throat or downstream through a sidestuffer. Additives can also be compounded into a masterbatch with a desired polymeric polymer and fed into the extruder. The extruder is generally operated at a temperature higher than that necessary to cause the composition to flow. The extrudate is immediately quenched in a water bath and pelletized. The pellets so prepared can be one-fourth inch long or less as desired. Such pellets can be used for subsequent molding, shaping, or forming.

Flammability tests were performed following the procedure of Underwriter's Laboratory Bulletin 94 entitled “Tests for Flammability of Plastic Materials for Parts in Devices and Appliances” (ISBN 0-7629-0082-2), Fifth Edition, Dated Oct. 29, 1996, incorporating revisions through and including Dec. 12, 2003. Several ratings can be applied based on the rate of burning, time to extinguish, ability to resist dripping, and whether or not drips are burning. According to this procedure, materials can be classified as UL-94 HB, V-0, V-1, V-2, 5VA and/or 5VB.

Shaped, formed, or molded articles including the polycarbonate compositions are also provided. The polycarbonate compositions can be molded into useful shaped articles by a variety of methods, such as injection molding, extrusion, rotational molding, blow molding and thermoforming. Some example of articles include computer and business machine housings such as housings for monitors, handheld electronic device housings such as housings for cell phones, electrical connectors, and components of lighting fixtures, ornaments, home appliances, roofs, greenhouses, sun rooms, swimming pool enclosures, and the like. In some aspects, the polycarbonate compositions can be used in articles such as mobile phones, tablets, industrial housings, electric circuit protection, personal safety helmets, electric vehicle supply equipment (EVSE) housings and connectors. In some aspects, the polycarbonate compositions can be used in applications such as industrial, building, and construction, automotive exteriors and interiors, electrical and electronics, sport/leisure, personal accessory, mass transportation, healthcare and consumer. It is also suitable for defense, outdoor lawn & landscape, water management, fossils, electrical devices & displays, specialty vehicles, surgical, ophthalmics, rail, home decoration, home appliances, electrical components and infrastructure, personal recreation, healthcare, patient testing, automotive under the hood, commercial appliance, industrial material handling and aerospace, and the like.

The polycarbonate compositions are further illustrated by the following non-limiting examples.

### EXAMPLES

The following components are used in the examples. Unless specifically indicated otherwise, the amount of each component is in wt %, based on the total weight of the composition.

The materials shown in Table 1 were used.

TABLE 1

| | | |
|---|---|---|
| PC-1 | Linear poly(bisphenol A carbonate), | SABIC |
| | Mw = 20,000-22,000 g/mol per GPC using | |
| | polystyrene standards and calculated | |
| | for polycarbonate | |
| PC-2 | Linear poly(bisphenol A carbonate), | SABIC |
| | Mw = 30,000-31,000 g/mol per GPC using | |
| | polystyrene standards and calculated | |
| | for polycarbonate | |
| PC-Si-1 | PDMS (polydimethylsiloxane)-Bisphenol | SABIC |
| | A polycarbonate copolymer, 20 wt % | |
| | siloxane, average PDMS block length 45 | |
| | units (D45), Mw 29,000-31,000 g/mol as | |
| | determined by GPC using polycarbonate | |
| | standards, eugenol end-capped | |
| Si-ADD | Masterbatch of 30 wt % ultra-high | MOMENTIVE |
| | molecular weight polysiloxane and | PERFORMANCE |
| | 70 wt % polycarbonate, available as | MATRIALS |
| | PEARLENE SiPC MB01 silicone | |
| KSS | Complex of potassium diphenylsulfone | ARICHEM |
| | sulfonate and diphenyl sulfone sulfonate | |
| ANTI- | Encapsulated Polytetrafluoroethylene, | SABIC |
| DRIP | CAS Reg. No. 9002-84-0, with 47-53 wt % | |
| | PTFE | |
| UVA | 2-[2-hydroxy-3,5-di-(1,1-dimethylbenyl)]- | BASF Corp. |
| | 2H-benzotriazol, available as TINUVIN 234 | |
| PETS | Pentaerythritol tetrastearate, >90% | Faci |
| | esterified | |
| TBPP | Tris(2,4-di-tert-butylphenyl) | BASF Corp. |
| | phosphite, CAS Reg. No. 31570-04-4; | |
| | available as IRGAFOS 168 | |
| TiO₂ | Titanium dioxide | |

The testing samples were prepared as described below and the following test methods were used.

Typical compounding procedures are described as follows: The various formulations were prepared by direct dry-blending of the raw materials and homogenized with a paint shaker prior to compounding. The formulations were compounded on a 26 mm Coperion ZSK co-rotating twin-screw extruder. A typical extrusion profile is listed in Table 2.

TABLE 2

| Parameters | Unit | 25 mm ZSK |
|---|---|---|
| Feed temperature | ° C. | 177 |
| Zone 1 temperature | ° C. | 232 |
| Zone 2-8 temperature | ° C. | 266 |
| Die temperature | ° C. | 271 |
| Screw speed | rpm | 400 |
| Throughput | kg/h | 70 |
| Torque | % | 75-80 |

A Demag molding machine was used to mold the test parts for standard physical property testing. (for parameters see Table 3).

TABLE 3

| Parameters | Unit | |
|---|---|---|
| Pre-drying time | h | 4 |
| Pre-drying temperature | ° C. | 120 |
| Zone 1-3 temperature | ° C. | 290 |
| Nozzle temperature | ° C. | 290 |
| Mold temperature | ° C. | 82 |
| Screw speed | rpm | 100 |
| Back pressure | bar | 3.4 |
| Injection time | s | 1-2 |
| Approx. cycle time | s | 31-35 |

Sample preparation and testing methods are described in Table 4. Need to add description and table for UL-94 flame testing.

TABLE 4

| Property | Standard | Conditions | | Specimen |
|---|---|---|---|---|
| Melt volume | ASTM D1238-04, | 300° C., 1.2 | | Pellets |
| rate (MVR) | Global test | kg, 6 min | | |
| | method | | | |
| Heat deflection | ASTM D648 | 1.82 | MPa | 3.18 mm bars |
| temperature (HDT) | | | | |
| Ductility | ASTM 256 | 23° | C. | 3.18 mm bars |

| | | | |
|---|---|---|---|
| Notched Izod | ASTM 256, | 23° C., 0° C. | 3.18 mm bars |
| Impact Strength | ASTM D4812 | | |
| Uniaxial | ASTM D638 | 23° C., | 3.18 mm bars |
| Tensile test | | 50 mm/min | |

Flammability tests were performed on samples at a thickness of 1.5 mm, 1.0 mm, and 0.8 mm in accordance with the Underwriter's Laboratory (UL) UL 94 standard. In some cases, a second set of 5 bars was tested to give an indication of the robustness of the rating. In this report the following definitions are used as shown in Table 5. Total flame-out-times (FOT) for all bars (FOT=t1+t2) were determined. V-ratings were obtained for every set of 10 bars, 5 conditioned for 48 hours at 23° C., 5 conditioned for 168 hours at 70° C.

TABLE 5

| | | 5-bar | burning drips |
|---|---|---|---|
| | t₁ and/or t₂ | cumulative FOT | igniting cotton |
| V-0 | <10 | <50 | No |
| V-1 | <30 | <250 | No |
| V-2 | <30 | <250 | Yes |
| N.R. (no rating) | >30 | >250 | |

### Examples 1-8

Table 6 shows the compositions and properties for the following comparative examples and examples. Comparative examples are indicated with an asterisk.

TABLE 6

| | Unit | 1* | 2* | 3* | 4* | 5 | 6 | 7 | 8 |
|---|---|---|---|---|---|---|---|---|---|
| PC-1 | wt % | 41.75 | 41.9 | 41.4 | 42.15 | 40.81 | 42.47 | 40.21 | 42.78 |
| PC-2 | wt % | 31.76 | 31.91 | 31.41 | 32.16 | 31.0 | 32.34 | 30.6 | 32.53 |
| PC-Si-1 | wt % | 22.2 | 22.2 | 22.2 | 22.2 | 22.2 | 19.2 | 22.2 | 17.7 |
| Si-ADD | wt % | | | 1.0 | 1.0 | 2.0 | 2.0 | 3.0 | 3.0 |
| KSS | wt % | 0.3 | 0.3 | 0.3 | 0.3 | 0.3 | 0.3 | 0.3 | 0.3 |
| ANTI-DRIP | wt % | 0.3 | | | | | | | |
| UVA | wt % | 0.3 | 0.3 | 0.3 | 0.3 | 0.3 | 0.3 | 0.3 | 0.3 |
| PETS | wt % | 0.3 | 0.3 | 0.3 | 0.3 | 0.3 | 0.3 | 0.3 | 0.3 |
| TBPP | wt % | 0.09 | 0.09 | 0.09 | 0.09 | 0.09 | 0.09 | 0.09 | 0.09 |
| TiO₂ | wt % | 3.0 | 3.0 | 3.0 | 3.0 | 3.0 | 3.0 | 3.0 | 3.0 |
| Total | wt % | 100 | 100 | 100 | 100 | 100 | 100 | 100 | 100 |
| % Si | wt % | 4.44 | 4.44 | 4.73 | 4.73 | 5.04 | 4.44 | 5.34 | 4.44 |
| % Si from | wt % | 4.44 | 4.44 | 4.44 | 4.44 | 4.44 | 3.84 | 4.44 | 3.54 |
| PC-Si | | | | | | | | | |
| % Si from | wt % | | | 0.3 | 0.3 | 0.6 | 0.6 | 0.9 | 0.9 |
| Si-ADD | | | | | | | | | |
| Ratio | | | | | | 1:7.4 | 1:6.4 | 1:5 | 1:3.9 |
| UL-94, 1.5 mm | | V-1 | V-2 | V-2 | V-2 | V-0 | V-0 | V-0 | V-0 |
| thickness | | | | | | | | | |
| # drips, | | 0 | 3 | 4 | 5 | 0 | 0 | 0 | 0 |
| 23° C., 48 h | | | | | | | | | |
| # drips, | | 0 | 4 | 0 | 3 | 0 | 0 | 0 | 0 |
| 70° C., 168 h | | | | | | | | | |
| FOT >10 s, | s | 1 | 3 | 1 | 2 | 0 | 0 | 0 | 0 |

Table 6 shows compositions including a combination of BPA homopolycarbonates (PC-1, PC-2) with a combination of a poly(carbonate-siloxane) including a higher siloxane content (i.e., 40 wt %) and a poly(carbonate-siloxane) including a lower siloxane content (i.e., 20 wt %), and a flame retardant that were used to prepare molded samples having a white color. TiO₂ was chosen as a colorant because it is a challenge to produce white molded samples with a UL-94 flame test rating of V-0 at 1.5 mm. Comparative Example 1 includes an anti-drip agent (TSAN) and an anti-drip agent is excluded from the rest of the compositions in Table 6. Comparative Examples 1 and 2 show that removal of the anti-drip agent results in an adverse effect on the UL-94 flame test rating (from V-1 to V-2), the number of drips (from no drips to 3 at 23° C. and from no drips to 4 at 70° C., some of which ignited the cotton), and the FOT (from 1 to 3). The FOT is a measure of how many of the molded bars had a flame-out time of greater than 10 s. No anti-drip agent was present in Examples 3-8. Instead, a UHMW polydimethylsiloxane was incorporated. Incorporation of the UHMW polydimethylsiloxane (loading of 1 wt %, 0.3 wt % siloxane content based on the total weight of the composition) failed to improve the UL-94 flame test rating, the number of drips, or the FOT. When the UHMW polydimethylsiloxane was increased to 2 wt % and 3 wt %, the desired combination of a UL-94 flame testing rating of V-0 at a 1.5 mm thickness, no drips at 23° C. or 70° C., and a FOT of 0 s were obtained (see Examples 5-8). Although Example 5 has a higher siloxane content as compared with Comparative Examples 1-4, it was the presence of the UHMW polydimethylsiloxane (at a loading of greater than 1 wt %, corresponding to greater than 0.3 wt % siloxane content, based on the total weight of the composition) and not the overall siloxane content (contributed by both the UHMW polydimethylsiloxane and the poly(carbonate-siloxane) that provided the desired combination of properties. Indeed, as demonstrated by Comparative Example 2 and Examples 6 and 8, wherein an anti-drip agent is absent, even when the siloxane content of the total composition is the same (i.e., 4.44 wt %) the desired combination of properties was not obtained when the UHMW polydimethylsiloxane was not present. Example 7 showed that increasing the total siloxane content to 5.34 wt % also provided the desired combination of properties.

This disclosure further encompasses the following aspects.

Aspect 1. A polycarbonate composition including a linear homopolycarbonate and optionally, a styrene-containing copolymer; a poly(carbonate-siloxane) including a siloxane content of about 10 to less than about 30 wt % siloxane, present in amount effective to provide about 1 to about 6 wt % siloxane content, based on the total weight of the poly(carbonate-siloxane); an ultra-high molecular weight polydimethylsiloxane, present in an amount effective to provide greater than about 0.3 to less than about 0.9 wt % siloxane, based on the total weight of the composition, wherein the weight average molecular weight of the polydimethylsiloxane is at least 100,000 grams per mole as determined by gel permeation chromatography according to polystyrene standards; a flame retardant; and optionally, an additive composition, wherein the linear homopolycarbonate, the optional styrene-containing copolymer, the poly(carbonate-siloxane), the ultra-high molecular weight polydimethylsiloxane, the flame retardant, and the optional additive composition total 100 wt %.

Aspect 1a. The polycarbonate composition of Aspect 1, wherein the additive composition comprises up to about 10 wt %, or up to about 5 wt % of the polycarbonate composition.

Aspect 1b. The polycarbonate composition of any one of the preceding aspects including about 60 to about 95 wt %, preferably about 65 to about 95 wt %, more preferably about 70 to about 95 wt % of the linear homopolycarbonate and optional styrene-containing copolymer.

Aspect 1c. The polycarbonate composition of any one of the preceding aspects, wherein the additive composition comprises an impact modifier, a flow modifier, a filler, a reinforcing agent, an antioxidant, a heat stabilizer, a light stabilizer, an ultraviolet light stabilizer, an ultraviolet absorbing additive, a plasticizer, a lubricant, a release agent, an antistatic agent, an anti-fog agent, an antimicrobial agent, a colorant, a surface effect additive, a radiation stabilizer, or a combination thereof.

Aspect 1d. The polycarbonate composition of any one of the preceding aspects, wherein the additive composition comprises an impact modifier, a flow modifier, a reinforcing agent, an antioxidant, a heat stabilizer, a light stabilizer, an ultraviolet light stabilizer, an ultraviolet absorbing additive, a plasticizer, a lubricant, a release agent, an antistatic agent, an anti-fog agent, an antimicrobial agent, a colorant, a surface effect additive, a radiation stabilizer, or a combination thereof.

Aspect 1e. The polycarbonate composition of any one of the preceding aspects, wherein the additive composition comprises an impact modifier, a flow modifier, an antioxidant, a heat stabilizer, a light stabilizer, an ultraviolet light stabilizer, an ultraviolet absorbing additive, a plasticizer, a lubricant, a release agent, an antistatic agent, an anti-fog agent, an antimicrobial agent, a colorant, a surface effect additive, a radiation stabilizer, or a combination thereof.

Aspect 1f. The polycarbonate composition of any one of the preceding aspects, wherein the additive composition comprises a flow modifier, a reinforcing agent, an antioxidant, a heat stabilizer, a light stabilizer, an ultraviolet light stabilizer, an ultraviolet absorbing additive, a plasticizer, a lubricant, a release agent, an antistatic agent, an anti-fog agent, an antimicrobial agent, a colorant, a surface effect additive, a radiation stabilizer, or a combination thereof.

Aspect 2. The polycarbonate composition of any one of the preceding aspects, wherein the calculated wt % of the bromine and chlorine content of the polycarbonate composition are each about 900 ppm or less and the calculated wt % of total halogen content of the polycarbonate composition is about 1500 ppm or less; or the calculated wt % of bromine, chlorine, and fluorine content of the polycarbonate composition are each about 900 ppm or less and the calculated wt % total bromine, chlorine, and fluorine content of the polycarbonate composition is about 1500 ppm or less.

Aspect 3. The polycarbonate composition of aspect 1, wherein a molded sample including the polycarbonate composition exhibits a UL-94 rating of V-0 at a thickness of 1.5 millimeters or less.

Aspect 4. The polycarbonate composition of any of the preceding aspects, wherein the poly(carbonate-siloxane) comprises repeating diorganosiloxane units of formula (10)

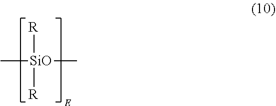

wherein each R is independently a C₁₋₁₃ monovalent organic group, preferably C₁₋₁₃ alkyl, C₁₋₁₃ alkoxy, C₂₋₁₃ alkenyl, C₂₋₁₃ alkenyloxy, C₃₋₆ cycloalkyl, C₃₋₆ cycloalkoxy, C₆₋₁₄ aryl, C₆₋₁₀ aryloxy, C₇₋₁₃ arylalkylene, C₇₋₁₃ arylalkylenoxy, C₇₋₁₃ alkylarylene, or C₇₋₁₃ alkylaryleneoxy, each optionally fully or partially halogenated with fluorine, chlorine, bromine, or iodine, or a combination thereof.

Aspect 5. The polycarbonate composition of any one of the preceding aspects, wherein the linear homopolycarbonate is a bisphenol A polycarbonate homopolymer including a linear bisphenol A polycarbonate homopolymer having a weight average molecular weight of 15,000 to 25,000 g/mol, preferably 17,000 to 25,000 g/mol, as determined by gel permeation chromatography according to polystyrene standards and calculated for polycarbonate; or a linear bisphenol A polycarbonate homopolymer having a weight average molecular weight of 26,000 to 40,000 g/mol, preferably 27,000 to 35,000 g/mol, as determined by gel permeation chromatography according to polystyrene standards and calculated for polycarbonate; or a combination thereof.

Aspect 6. The polycarbonate composition of any one of the preceding aspects, wherein the poly(carbonate siloxane) comprises bisphenol A carbonate repeating units and poly(dimethyl siloxane) repeating units.

Aspect 7. The polycarbonate composition of any one of the preceding aspects, wherein the poly(carbonate siloxane) has a siloxane content of about 15 to about 25 wt %, based on the total weight of the poly(carbonate siloxane).

Aspect 8. The polycarbonate composition of any one of the preceding aspects, wherein the flame retardant comprises an alkyl sulfonate salt, an aromatic sulfonate salt, an organophosphorous compound, or a combination thereof.

Aspect 9. The polycarbonate composition of any one of the preceding aspects, wherein the flame retardant is a not halogenated.

Aspect 10. The polycarbonate composition of any one of the preceding aspects, wherein the styrene-containing copolymer is present and comprises an elastomeric phase including (i) a butadiene and having a glass transition temperature of less than 10° C., and (ii) a rigid polymeric phase having a glass transition temperature of greater than 15° C. and including a copolymer of a monovinylaromatic monomer including styrene and an unsaturated nitrile.

Aspect 11. The polycarbonate composition of any one of the preceding aspects, wherein the composition excludes a halogenated anti-drip agent, preferably a fluorinated anti-drip agent.

Aspect 12. The polycarbonate composition of any one of the preceding aspects including a linear homopolycarbonate and optionally, a styrene-containing copolymer; a poly(carbonate-siloxane) including a siloxane content of about 10 to less than about 30 wt % siloxane, present in amount effective to provide about 1 to about 6 wt % siloxane content, based on the total weight of the polycarbonate composition; an ultra-high molecular weight polydimethylsiloxane, present in an amount effective to provide greater than about 0.3 to less than about 0.9 wt % siloxane, based on the total weight of the composition, wherein the weight average molecular weight of the polydimethylsiloxane is at least 100,000 grams per mole as determined by gel permeation chromatography according to polystyrene standards; and a flame retardant including an aromatic sulfonate salt; and optionally, an additive composition.

Aspect 12a. The polycarbonate composition of Aspect 12, wherein the styrene-containing copolymer is present and comprises styrene-butadiene-styrene (SBS), styrene-butadiene rubber (SBR), styrene-ethylene-butadiene-styrene (SEBS), acrylonitrile-butadiene-styrene (ABS), acrylonitrile-ethylene-propylene-diene-styrene (AES), styrene-isoprene-styrene (SIS), methyl methacrylate-butadiene-styrene (MBS), styrene-acrylonitrile (SAN), or a combination thereof, preferably acrylonitrile-butadiene-styrene (ABS).

Aspect 13. A method of making the polycarbonate composition of any one of the preceding aspects, the method including melt-mixing the components of the composition.

Aspect 14. The method of aspect 13, further including molding, casting, or extruding the composition to provide the article.

Aspect 15. An article including the polycarbonate composition of any one of the preceding aspects.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “About” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5%, 1%, 0.5%, 0.2%, or 0.1% of the stated value.

“Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination including at least one of the listed components or properties optionally together with a like or equivalent component or property not listed.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

The term “alkyl” means a branched or straight chain, unsaturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo groups (e.g., bromo and fluoro), or only chloro groups can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl) a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A polycarbonate composition comprising:
a linear homopolycarbonate and optionally, a styrene-containing copolymer;
a poly(carbonate-siloxane) comprising about 10 wt % to about 30 wt % siloxane, present in amount effective to provide about 1 to about 6 wt % siloxane content, based on the total weight of the polycarbonate composition;
an ultra-high molecular weight polydimethylsiloxane, present in an amount effective to provide greater than about 0.3 wt % to less than about 0.9 wt % siloxane, based on the total weight of the composition, wherein the weight average molecular weight of the polydimethylsiloxane is at least 100,000 grams per mole as determined by gel permeation chromatography according to polystyrene standards; and
a flame retardant; and
optionally, up to about 5 wt % of an additive composition,
wherein the linear homopolycarbonate, the optional styrene-containing copolymer, the poly(carbonate-siloxane), the ultra-high molecular weight polydimethylsiloxane, the flame retardant, and the optional additive composition total 100 wt %.

2. A polycarbonate composition comprising:
about 65 to about 95 wt % of a linear homopolycarbonate and optionally, a styrene-containing copolymer;
a poly(carbonate-siloxane) comprising a siloxane content of about 10 wt % to about 30 wt % siloxane, present in amount effective to provide about 1 to about 6 wt % siloxane content, based on the total weight of the polycarbonate composition;
an ultra-high molecular weight polydimethylsiloxane, present in an amount effective to provide greater than about 0.3 wt % to less than about 0.9 wt % siloxane, based on the total weight of the composition, wherein the weight average molecular weight of the polydimethylsiloxane is at least 100,000 grams per mole as determined by gel permeation chromatography according to polystyrene standards; and
a flame retardant; and
optionally, up to about 10 wt % of an additive composition wherein the linear homopolycarbonate, the optional styrene-containing copolymer, the poly(carbonate-siloxane), the ultra-high molecular weight polydimethylsiloxane, the flame retardant, and the optional additive composition total 100 wt %.

3. The polycarbonate composition of claim 1, wherein
the calculated wt % of bromine and chlorine content of the polycarbonate composition are each about 900 ppm or less and the calculated wt % of total halogen content of the polycarbonate composition is about 1500 ppm or less; or
the calculated wt % of bromine, chlorine, and fluorine content of the polycarbonate composition are each about 900 ppm or less and the calculated wt % of total bromine, chlorine, and fluorine content of the polycarbonate composition is about 1500 ppm or less.

4. The polycarbonate composition of claim 1, wherein a molded sample comprising the polycarbonate composition exhibits a UL-94 rating of V-0 at a thickness of 1.5 millimeters or less.

5. (canceled)

6. The polycarbonate composition of claim 1, wherein the linear homopolycarbonate is a bisphenol A polycarbonate homopolymer comprising
a linear bisphenol A polycarbonate homopolymer having a weight average molecular weight of 15,000 to 25,000 g/mol; or
a linear bisphenol A polycarbonate homopolymer having a weight average molecular weight of 26,000 to 40,000 g/mol; or
a combination thereof.

7. The polycarbonate composition of claim 1, wherein the poly(carbonate siloxane) comprises bisphenol A carbonate repeating units and poly (dimethyl siloxane) repeating units.

8. The polycarbonate composition of claim 1, wherein the poly(carbonate siloxane) has a siloxane content of about 15 to about 25 wt %, based on the total weight of the poly(carbonate siloxane).

9. The polycarbonate composition of claim 1, wherein the flame retardant comprises an alkyl sulfonate salt, an aromatic sulfonate salt, an organophosphorous compound, or a combination thereof.

10. The polycarbonate composition of claim 1, wherein the flame retardant is not halogenated.

11. The polycarbonate composition claim 1, wherein the styrene-containing copolymer is present and comprises an elastomeric phase comprising (i) a butadiene and having a glass transition temperature of less than 10° C., and (ii) a rigid polymeric phase having a glass transition temperature of greater than 15° C. and comprising a copolymer of a monovinylaromatic monomer comprising styrene and an unsaturated nitrile.

12. The polycarbonate composition of claim 1, wherein the composition excludes a halogenated anti-drip agent.

13. A method of making the polycarbonate composition of claim 1, the method comprising melt-mixing the components of the composition.

14. The method of claim 13, further comprising molding, casting, or extruding the composition to provide the article.

15. An article comprising the polycarbonate composition of claim 1.

16. The polycarbonate composition of claim 12, wherein the composition excludes a fluorinated anti-drip agent.

17. The polycarbonate composition of claim 2, wherein
the calculated wt % of bromine and chlorine content of the polycarbonate composition are each about 900 ppm or less and the calculated wt % of total halogen content of the polycarbonate composition is about 1500 ppm or less; or
the calculated wt % of bromine, chlorine, and fluorine content of the polycarbonate composition are each about 900 ppm or less and the calculated wt % of total bromine, chlorine, and fluorine content of the polycarbonate composition is about 1500 ppm or less.

18. The polycarbonate composition of claim 2, wherein the composition excludes a halogenated anti-drip agent, and wherein a molded sample comprising the polycarbonate composition exhibits a UL-94 rating of V-0 at a thickness of 1.5 millimeters or less, and.

19. The polycarbonate composition of claim 2, wherein the linear homopolycarbonate is a bisphenol A polycarbonate homopolymer comprising
a linear bisphenol A polycarbonate homopolymer having a weight average molecular weight of 15,000 to 25,000 g/mol; or
a linear bisphenol A polycarbonate homopolymer having a weight average molecular weight of 26,000 to 40,000 g/mol; or
a combination thereof.

20. The polycarbonate composition of claim 2, wherein the poly(carbonate siloxane) comprises bisphenol A carbonate repeating units and poly(dimethyl siloxane) repeating units.

21. The polycarbonate composition claim 2, wherein the styrene-containing copolymer is present and comprises an elastomeric phase comprising (i) a butadiene and having a glass transition temperature of less than 10° C., and (ii) a rigid polymeric phase having a glass transition temperature of greater than 15° C. and comprising a copolymer of a monovinylaromatic monomer comprising styrene and an unsaturated nitrile.
